(19) United States
(12) Patent Application Publication
(10) Pub. No.: US 2021/0026156 A1
(43) Pub. Date: Jan. 28, 2021

(54) Glasses

(71) Applicant: Sun Sight Glasses Co., Ltd., Tainan City (TW)

(72) Inventor: Jui-Chi Li, Tainan City (TW)

(21) Appl. No.: 16/520,447

(22) Filed: Jul. 24, 2019

(51) Int. Cl. G02C 1/08

(52) U.S. Cl. CPC G02C 1/08; G02C 2200/02

(57) ABSTRACT

Glasses include a glass upper frame, a glass lower frame, the lens, and a bridge. Each of two ends of the glass upper frame dents to form a downward-opening receiving cavity of predetermined depth. Each of two ends of the glass lower frame dents to form a receiving cavity of predetermined depth. Magnetic elements are fitted snugly into the receiving cavities. An elevated portion is centrally disposed at the glass lower frame and corresponds in position to a slot dentedly-formed at the bridge such that a complete stop groove is formed along the glass lower frame when the bridge is fitted to the glass lower frame. The bottom edge of the glass upper frame dents to form a groove. Each of the two ends of the glass upper frame dents to form an inward-opening dented portion. The groove, dented portions, stop groove, and bridge jointly hold the lens.

### BACKGROUND OF THE INVENTION

### 1. Technical Field

The present disclosure provides glasses which render it easy to remove frames which a lens is coupled to, the lens, and a nose pad for replacement and enable them to engage with each other again, so as to attain temporary directional restriction without compromising the application of the frames, lens and a nose pad.

### 2. Description of Related Art

The functions of glasses depend on their purposes. For instance, lenses and frames of corrective glasses for correcting refractive errors, sunglasses for protecting eyes against bright light outdoors, and sports glasses for protecting eyes in sports can be changed by users as needed, easily and conveniently, so as to alter the color of the lenses in use and/or alter the frames in use.

### BRIEF SUMMARY OF THE INVENTION

The present disclosure aims to render it easy to remove frames which a lens is coupled to, the lens, and a nose pad for replacement and enable them to engage with each other again, so as to attain positioning quickly and temporarily. To this end, glasses of the present disclosure comprise a glass upper frame, a glass lower frame, a lens, and a bridge, wherein each of two ends of the glass upper frame dents to form a downward-opening receiving cavity of a predetermined depth, each of two ends of the glass lower frame dents to form a receiving cavity of a predetermined depth, magnetic elements are fitted snugly into the receiving cavities, respectively, an elevated portion is centrally disposed at the glass lower frame and corresponds in position to a slot dentedly-formed at the bridge such that a complete stop groove is formed along the glass lower frame as soon as the bridge is fitted to the glass lower frame, wherein a bottom edge of the glass upper frame dents to form a groove, each of the two ends of the glass upper frame dents to form an inward-opening dented portion, allowing the groove and the dented portions of the glass upper frame, the stop groove of the glass lower frame, and the bridge to jointly hold the lens, such that the magnetic elements disposed at the two ends of the glass upper frame and the magnetic elements disposed at the two ends of the glass lower frame together enable temporary directional restriction to therefore attain quick positioning, and changing the glass upper frame, glass lower frame, lens and/or a nose pad entails removing the glass lower frame, then changing the glass upper frame, the glass lower frame, the lens, and/or the bridge, and thereby enabling temporary directional restriction with the magnetic elements. Therefore, the glasses achieve quick positioning and allow the glass lower frame to be removed to facilitate replacement of the frames, the lens and/or the bridge and facilitate subsequent engagement thereof.

The first objective of the present disclosure is to render it easy to remove frames which a lens is coupled to, the lens, and a nose pad for replacement and enable them to engage with each other again, so as to attain positioning quickly and temporarily. To this end, glasses of the present disclosure comprise a glass upper frame, a glass lower frame, a lens, and a bridge, wherein each of two ends of the glass upper frame dents to form a downward-opening receiving cavity of a predetermined depth, each of two ends of the glass lower frame dents to form a receiving cavity of a predetermined depth, magnetic elements are fitted snugly into the receiving cavities, respectively, an elevated portion is centrally disposed at the glass lower frame and corresponds in position to a slot dentedly-formed at the bridge such that a complete stop groove is formed along the glass lower frame as soon as the bridge is fitted to the glass lower frame, wherein a bottom edge of the glass upper frame dents to form a groove, each of the two ends of the glass upper frame dents to form an inward-opening dented portion, allowing the groove and the dented portions of the glass upper frame, the stop groove of the glass lower frame, and the bridge to jointly hold the lens, such that the magnetic elements disposed at the two ends of the glass upper frame and the magnetic elements disposed at the two ends of the glass lower frame together enable temporary directional restriction to therefore attain quick positioning, and changing the glass upper frame, glass lower frame, lens and/or a nose pad entails removing the glass lower frame, then changing the glass upper frame, the glass lower frame, the lens, and/or the bridge, and thereby enabling mutual directional restriction with the magnetic elements.

The second objective of the present disclosure is to allow a middle segment of the groove of the glass upper frame to extend and thereby form a hook portion corresponding in position to a notch dentedly-formed at the lens, allow the hook portion to be fitted into the notch, allow each of the two ends of the glass upper frame dents to form an inward-opening dented portion, allow two protruding portions to be disposed at the two ends of the lens, respectively, and fitted into the dented portions, respectively, such that the lens is fitted to the glass upper frame, enabling temporary directional restriction.

The third objective of the present disclosure is to allow the magnetic elements fitted snugly into the receiving cavities at the two ends of the glass lower frame to protrude slightly from the receiving cavities, respectively, and allow the magnetic elements fitted snugly into the receiving cavities at the two ends of the glass upper frame to sink slightly into the receiving cavities, respectively, such that the glass lower frame is fitted to the bottom edge of the lens and magnetically attracted to the slightly sunken magnetic elements at the two ends of the glass upper frame, enabling mutual engagement restriction.

In accordance with the objects of this invention, glasses is described for comprising an upper frame, a lower frame, a lens, a nose pad (exemplified by a bridge shown in the diagram), a magnetic member, a metal member. The upper frame has a cavity on its two ends and has a groove. The lower frame has a cavity on its two ends and have a blocking groove, and the cavity of the lower frame is corresponding to the cavity of the upper frame, and the lower frame has a curved portion toward the side of the upper frame on middle section. A lens which is located between the upper frame and the lower frame is detachably fixed to the upper frame and the lower frame by respectively inserting the lens into the groove and the blocking groove. A nose pad disposed on the curved portion and is located between the lower frame and the lens are detachably coupled to the lower frame and the lens. A nose pad have a slot in the middle section of the bridge. A magnetic member is closely disposed on the cavity of the upper frame. A metal member is closely disposed in the cavity of the lower frame, wherein the metal member is made of a group selected from the group consisting of iron, cobalt and nickel, or made of an alloy containing a group selected from the group consisting of iron, cobalt and nickel.

In accordance with the objects of this invention, glasses can be also described for comprising an upper frame, a lower frame, a lens, a nose pad (exemplified by a bridge shown in the diagram), a magnetic member, a metal member. The upper frame has a cavity on its two ends and has a groove. The lower frame has a cavity on its two ends and have a blocking groove, and the cavity of the lower frame is corresponding to the cavity of the upper frame, and the lower frame has a curved portion toward the side of the upper frame on middle section. A lens which is located between the upper frame and the lower frame is detachably fixed to the upper frame and the lower frame by respectively inserting the lens into the groove and the blocking groove. A nose pad disposed on the curved portion and is located between the lower frame and the lens are detachably coupled to the lower frame and the lens. A nose pad have a slot in the middle section of the bridge. A magnetic member is closely disposed on the cavity of the lower frame. A metal member is closely disposed in the cavity of the upper frame, wherein the metal member is made of a group selected from the group consisting of iron, cobalt and nickel, or made of an alloy containing a group selected from the group consisting of iron, cobalt and nickel.

Alternatively, the metal member is a magnetic member, so as to upgrade the magnetic attraction between the upper frame and lower frame.

In accordance with the objects of this invention, the upper frame further has a hook portion and the lens further has a notch, and the hook portion is detachably fixed to the notch. As stated above, the glasses of the present disclose a glasses that can be assembly quickly by arranging the metal member and magnetic member at the two ends of the upper frame and lower frame respectively or by arranging the magnetic member at the two ends of the upper frame and lower frame so as to improve the efficiency of assembly of the glasses.

### BRIEF DESCRIPTION OF THE SEVERAL VIEWS OF THE DRAWINGS

FIG. 1 is an exploded view of glasses of the present disclosure.

FIG. 2 is a perspective view of the glasses of the present disclosure.

FIG. 3 is a cross-sectional view taken of part A of the glasses shown in FIG. 2.

FIG. 4 is a cross-sectional view taken of the middle segment of the glasses of the present disclosure.

FIG. 5 is an exploded view of glasses of the present disclosure.

FIG. 6 is an exploded view of glasses of the present disclosure.

### DETAILED DESCRIPTION OF THE INVENTION

The glasses according to the embodiment of the present will be described with reference to the relevant figures.

It should be noted that all the directional indications (such as up, down, left, right, front, back, . . . ) in the embodiments of the present are only used to explain in a certain posture (such as the attached figures). The relative positional relationship between the components under the condition, the motion situation, etc., if the specific posture changes, the directionality indication will also change accordingly.

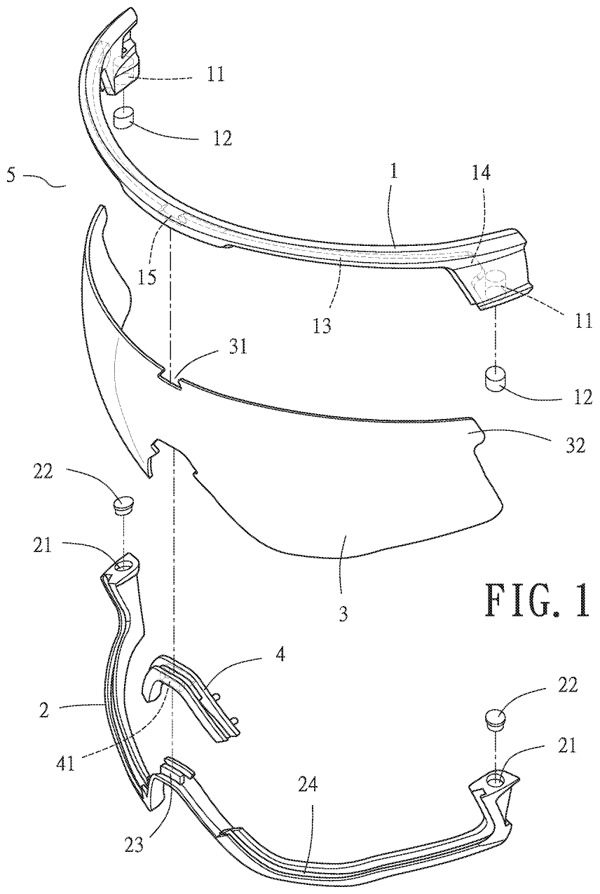

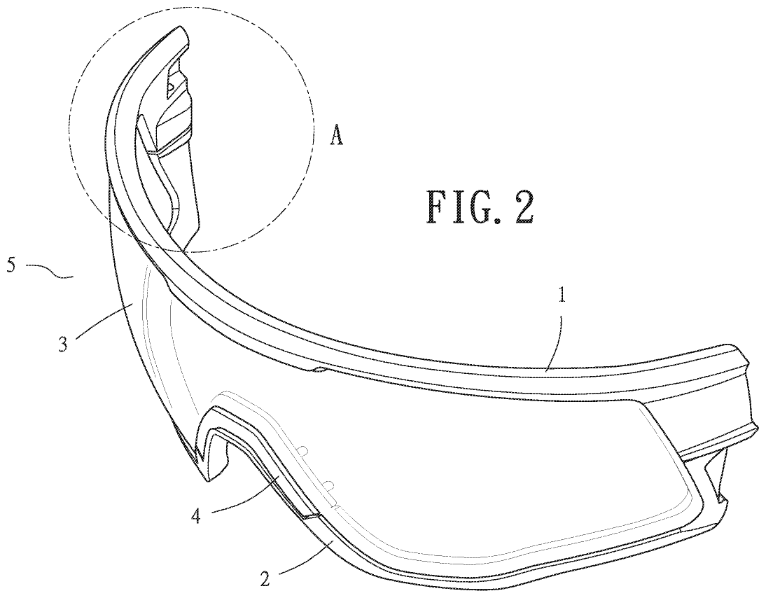

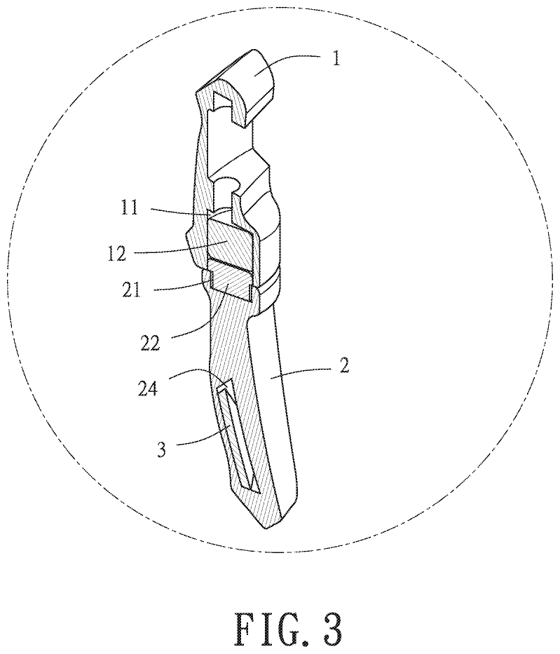

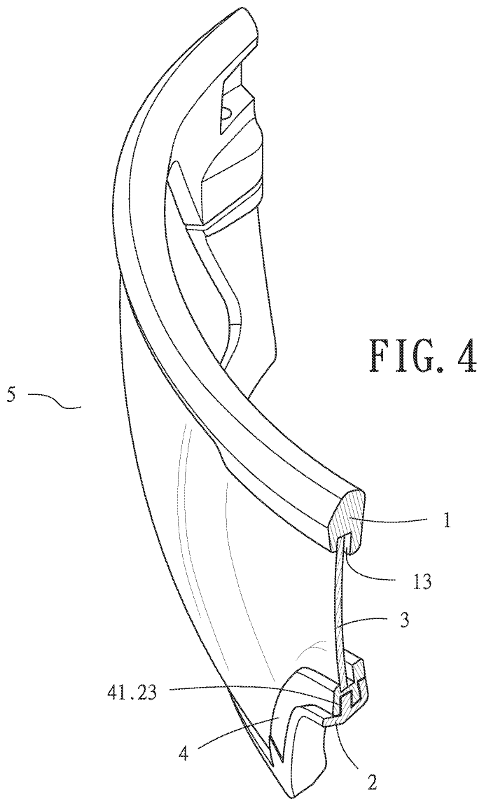

The present disclosure provides glasses 5 (shown in FIG. 1) conducive to positioning frames which a lens is coupled to, the lens, and a nose pad (exemplified by a bridge shown in the diagram) in place quickly and temporarily by easy disengagement and engagement. The glasses 5 comprise a glass upper frame 1, a glass lower frame 2, a lens 3, and a bridge 4. Each of the two ends of the glass upper frame 1 dents to form a downward-opening receiving cavity 11 of a predetermined depth. Each of the two ends of the glass lower frame 2 dents to form a receiving cavity 21 of a predetermined depth. Magnetic elements 12, 22 are fitted snugly into the receiving cavities 11, 21, respectively. An elevated portion 23 is centrally disposed at the glass lower frame 2 and corresponds in position to a slot 41 dentedly-formed at the bridge 4. As soon as the bridge 4 is fitted to the glass lower frame 2, a complete stop groove 24 (shown in FIG. 2) is formed along the glass lower frame 2. The bottom edge of the glass upper frame 1 dents to form a groove 13. Each of the two ends of the glass upper frame 1 dents to form an inward-opening dented portion 14. The groove 13 and the dented portions 14 of the glass upper frame 1, the stop groove 24 of the glass lower frame 2, and the bridge 4 jointly hold the lens 3, as shown in FIG. 4. Referring to FIG. 3, the magnetic elements 12 disposed at the two ends of the glass upper frame 1 and the magnetic elements 22 disposed at the two ends of the glass lower frame 2 together enable temporary directional restriction to therefore attain quick positioning. Changing the glass upper frame, glass lower frame, lens and/or a nose pad entails removing the glass lower frame 2, then changing the glass upper frame 1, the glass lower frame 2, the lens 3, and/or the bridge 4, and thereby enabling directional restriction with the magnetic elements 12, 22.

Regarding the glasses 5 described in paragraph [0010], the middle segment of the groove 13 of the glass upper frame 1 extends to form a hook portion 15 (shown in FIG. 1) corresponding in position to a notch 31 dentedly-formed at the lens 3; hence, the hook portion 15 can be fitted into the notch 31, allowing the glass upper frame 1 to hold the lens 3. Two protruding portions 32 are disposed at the two ends of the lens 3, respectively, and fitted into the dented portions 14, respectively. Therefore, the lens 3 is fitted to the glass upper frame 1, enabling temporary directional restriction.

Regarding the glasses 5 described in paragraph [0010], the magnetic elements 22 fitted snugly into the receiving cavities 21 at the two ends of the glass lower frame 2 protrude slightly from the receiving cavities 21, respectively, whereas the magnetic elements 12 fitted snugly into the receiving cavities 11 at the two ends of the glass upper frame 1 sink slightly into the receiving cavities 11, respectively, as shown in FIG. 3. Therefore, the glass lower frame 2 is fitted to the bottom edge of the lens 3 and magnetically attracted to the slightly sunken magnetic elements 12 at the two ends of the glass upper frame 1; this enables mutual engagement restriction, imposing better directional restriction on the glass upper frame 1 and the glass lower frame 2 at their two ends.

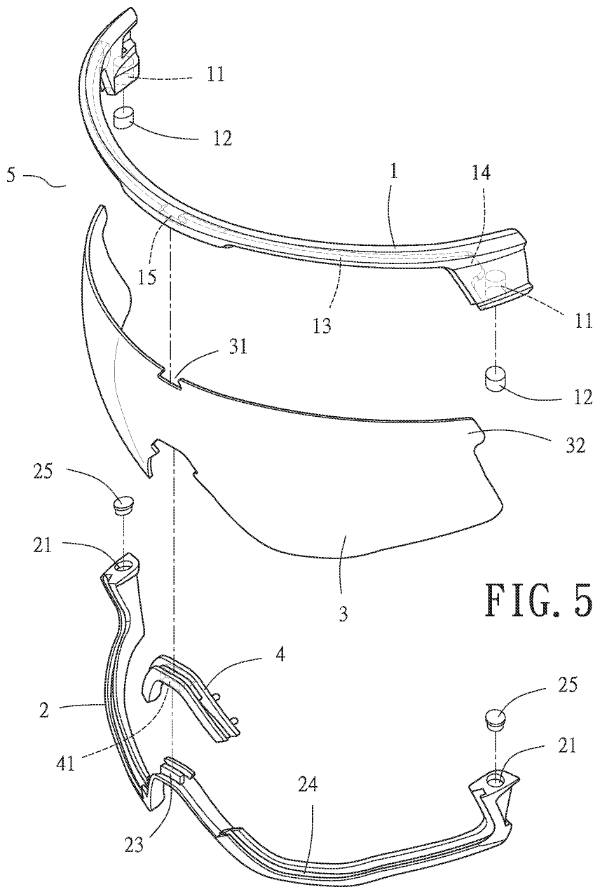

Referring to FIG. 5, in another embodiment, glasses is described for comprising an upper frame 1, a lower frame 2, a lens 3, a nose pad 4, a magnetic member 12, a metal member 25. The upper frame 1 has a cavity on its two ends and has a groove 13. The lower frame 2 has a cavity on its two ends and have a blocking groove 24, and the cavity 21 of the lower frame 2 is corresponding to the cavity 11 of the upper frame 1, and the lower frame 2 has a curved portion toward the side of the upper frame 1 on middle section. A lens 3 which is located between the upper frame 1 and the lower frame 2 is detachably fixed to the upper frame 1 and the lower frame 2 by respectively inserting the lens 3 into the groove 13 and the blocking groove 24. A nose pad 4 disposed on the curved portion and is located between the lower frame 2 and the lens 3 are detachably coupled to the lower frame 2 and the lens 3, and there is a slot 41 dentedly-formed at the bridge. A magnetic member 12 is closely disposed on the cavity 11 of the upper frame 1. A metal member 25 is closely disposed in the cavity 21 of the lower frame 2, wherein the metal member 25 is made of a group selected from the group consisting of iron, cobalt and nickel, or made of an alloy containing a group selected from the group consisting of iron, cobalt and nickel.

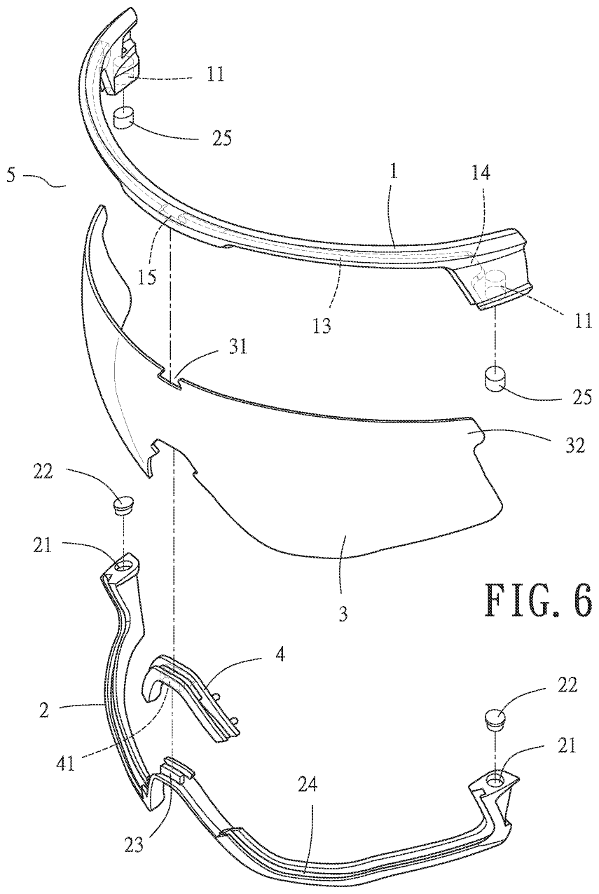

Referring to FIG. 6, in another embodiment, glasses is described for comprising an upper frame 1, a lower frame 2, a lens 3, a nose pad 4, a magnetic member 22, a metal member 25. The upper frame 1 has a cavity on its two ends and has a groove 13. The lower frame 2 has a cavity on its two ends and have a blocking groove 24, and the cavity 21 of the lower frame 2 is corresponding to the cavity 11 of the upper frame 1, and the lower frame 2 has a curved portion toward the side of the upper frame 1 on middle section. A lens 3 which is located between the upper frame 1 and the lower frame 2 is detachably fixed to the upper frame 1 and the lower frame 2 by respectively inserting the lens 3 into the groove 13 and the blocking groove 24. A nose pad 4 disposed on the curved portion and is located between the lower frame 2 and the lens 3 are detachably coupled to the lower frame 2 and the lens 3. and there is a slot 41 dentedly-formed at the bridge. A magnetic member 22 is closely disposed on the cavity 21 of the lower frame 2. A metal member 25 is closely disposed in the cavity 11 of the upper frame 1, wherein the metal member 25 is made of a group selected from the group consisting of iron, cobalt and nickel, or made of an alloy containing a group selected from the group consisting of iron, cobalt and nickel.

Alternatively, the metal member 25 is a magnetic member, so as to upgrade the magnetic attraction between the upper frame 1 and lower frame 2.

In accordance with the objects of this invention, the upper frame 1 further has a hook portion 15 and the lens 3 further has a notch, and the hook portion 15 is detachably fixed to the notch. As stated above, the glasses of the present disclose a glasses that can be assembly quickly by arranging the metal member 25 and magnetic member (12 or 22) at the two ends of the upper frame 1 and lower frame 2 respectively or by arranging the magnetic member 12, 22 at the two ends of the upper frame 1 and lower frame 2 so as to improve the efficiency of assembly of the glasses.

The above is merely descriptive and non-limiting description, so that the use or the thing according to any equivalent modification of the present are included in the scope of the appended claims.

What is claimed is:

1. Glasses, conducive to positioning frames which a lens is coupled to, the lens, and a nose pad in place quickly and temporarily by easy disengagement and engagement, the glasses comprising a glass upper frame, a glass lower frame, the lens, and a bridge, wherein each of two ends of the glass upper frame dents to form a downward-opening receiving cavity of a predetermined depth, each of two ends of the glass lower frame dents to form a receiving cavity of a predetermined depth, magnetic elements are fitted snugly into the receiving cavities, respectively, an elevated portion is centrally disposed at the glass lower frame and corresponds in position to a slot dentedly-formed at the bridge such that a complete stop groove is formed along the glass lower frame as soon as the bridge is fitted to the glass lower frame,
wherein a bottom edge of the glass upper frame dents to form a groove, each of the two ends of the glass upper frame dents to form an inward-opening dented portion, allowing the groove and the dented portions of the glass upper frame, the stop groove of the glass lower frame, and the bridge to jointly hold the lens, such that the magnetic elements disposed at the two ends of the glass upper frame and the magnetic elements disposed at the two ends of the glass lower frame together enable temporary directional restriction to therefore attain quick positioning, and changing the glass upper frame, glass lower frame, lens and/or a nose pad entails removing the glass lower frame, then changing the glass upper frame, the glass lower frame, the lens, and/or the bridge, and thereby enabling directional restriction with the magnetic elements.

2. The glasses of claim 1, wherein a middle segment of the groove of the glass upper frame extends to form a hook portion corresponding in position to a notch dentedly-formed at the lens, the hook portion can be fitted into the notch, allowing the glass upper frame to hold the lens, two protruding portions are disposed at the two ends of the lens, respectively, and fitted into the dented portions, respectively, such that the lens is fitted to the glass upper frame, enabling temporary directional restriction.

3. The glasses of claim 1, wherein the magnetic elements fitted snugly into the receiving cavities at the two ends of the glass lower frame protrude slightly from the receiving cavities, respectively, whereas the magnetic elements fitted snugly into the receiving cavities at the two ends of the glass upper frame sink slightly into the receiving cavities, respectively, such that the glass lower frame is fitted to the bottom edge of the lens and magnetically attracted to the slightly sunken magnetic elements at the two ends of the glass upper frame, enabling mutual engagement restriction.

4. Glasses comprising:
an upper frame has a cavity on its two ends and has a groove;
a lower frame has a cavity on its two ends and have a blocking groove, and the cavity of the lower frame is corresponding to the cavity of the upper frame;
a lens which is located between the upper frame and the lower frame is detachably fixed to the upper frame and the lower frame by respectively inserting the lens into the groove and the blocking groove;
a nose pad disposed on the curved portion and is located between the lower frame and the lens are detachably coupled to the lower frame and the lens, and there is a slot dentedly-formed at the nose pad;
a magnetic member is closely disposed on the cavity of the upper frame;
a metal member is closely disposed in the cavity of the lower frame, wherein the metal member is made of a group selected from the group consisting of iron, cobalt and nickel, or made of an alloy containing a group selected from the group consisting of iron, cobalt and nickel.

5. The glasses of claim 4, wherein the upper frame further has a hook portion and the lens further has a notch, and the hook portion is detachably fixed to the notch.

6. The glasses of claim 5, wherein the metal member is a magnetic member.

7. Glasses comprising:
an upper frame has a cavity on its two ends and has a groove;
a lower frame has a cavity on its two ends and have a blocking groove, and the cavity of the lower frame is corresponding to the cavity of the upper frame;
a lens which is located between the upper frame and the lower frame is detachably fixed to the upper frame and the lower frame by respectively inserting the lens into the groove and the blocking groove;
a nose pad disposed on the curved portion and is located between the lower frame and the lens are detachably coupled to the lower frame and the lens, and there is a slot dentedly-formed at the nose pad;
a magnetic member is closely disposed on the cavity of the lower frame;
a metal member is closely disposed in the cavity of the upper frame, wherein the metal member is made of a group selected from the group consisting of iron, cobalt and nickel, or made of an alloy containing a group selected from the group consisting of iron, cobalt and nickel.

8. The glasses of claim 7, wherein the upper frame further has a hook portion and the lens further has a notch, and the hook portion is detachably fixed to the notch.

9. The glasses of claim 8, wherein the metal member is a magnetic member.
